(19) United States
(12) Patent Application Publication
(10) Pub. No.: US 2011/0187446 A1
(43) Pub. Date: Aug. 4, 2011

(54) SEMICONDUCTOR DEVICE

(75) Inventor: Akihiro Hirota, Tokyo (JP)

(73) Assignee: OKI SEMICONDUCTOR CO., LTD., Tokyo (JP)

(21) Appl. No.: 13/008,445

(22) Filed: Jan. 18, 2011

(30) Foreign Application Priority Data
Jan. 29, 2010 (JP) 2010-019729

(51) Int. Cl. G05F 1/56

(52) U.S. Cl. 327/541

(57) ABSTRACT

A semiconductor device includes a bonding option pad, an internal power supply, and a MOS transistor. The bonding option pad is selectively wire-bonded to two voltage supply portions through which external power supply voltages with different power supply potentials are supplied from an external power supply. The internal power supply is caused to generate a pre-specified internal power supply voltage. The MOS transistor stabilizes an output level of the internal power supply voltage. The source and drain of the MOS transistor are shorted together and connected to the bonding option pad, and the gate there.

### CROSS-REFERENCE TO RELATED APPLICATION

This application is based on and claims priority under 35 USC 119 from Japanese Patent Application No. 2010-019729 filed on Jan. 29, 2010, the disclosure of which is incorporated by reference herein.

### BACKGROUND

1. Technical Field

The present invention relates to a semiconductor device, and particularly relates to a semiconductor device that may be switched to manufactured products with different functions by so-called bonding options.

2. Related Art

Heretofore, a stabilizing capacitance element has been connected to a power supply output line through which a power supply voltage is outputted, in order to stabilize the output level of the power supply voltage (for example, see Japanese Patent Application Laid-Open (JP-A) No. 2007-93696).

When a stabilizing capacitance element is to be connected to a power supply output line of an internal power supply that is used for supplying power to circuits inside a semiconductor device, such as a semiconductor memory or the like, in order to stabilize the output level of the internal power supply, as an example, an element in which the source and drain of an NMOS transistor 100 are connected as illustrated in FIG. 8 may be used as the stabilizing capacitance element.

In such a case heretofore, it has been usual to connect the source and drain of the NMOS transistor 100 to Vss, that is, to ground, and to connect the gate to a power supply output line 102 through which the power supply voltage from an internal power supply IV is outputted.

When switching between manufactured products by what are known as bonding options, similarly, a source and drain are fixedly connected to Vss.

However, with the configuration described above, there is a problem as described below when a single semiconductor device is to be switched between two manufactured products with different functions by bonding options.

As an example, a case of switching by a bonding option from the same semiconductor device to two manufactured products A and B with different standby current standards, access standards and internal power supply operations, as illustrated in FIG. 9, is described.

The manufactured products A and B are the same semiconductor device (semiconductor integrated circuit or semiconductor chip), which is specified to switch function with a bonding option. As illustrated in FIG. 9, manufactured product A has a standby current standard of 100 μA and an access standard of 70 ns, and manufactured product B has a standby current standard of 10 μA and an access standard of 150 ns. In other words, the standby current standard is stricter for manufactured product B than for manufactured product A, and the access standard is more relaxed for manufactured product B than for manufactured product A.

A required current consumption during operation of an internal power supply of this semiconductor device is, for example, 30 μA, and a generation level of the internal power supply IV is, for example, 2.5 V.

When the two manufactured products are switched between by the bonding option, in manufactured product A, it is necessary for the internal power supply N to continuously generate power because high-speed access is required. On the other hand, in manufactured product B, in order to meet the standby current standard, the internal power supply IV does not generate power during standby, but when an active start is received—specifically, when a chip enable signal CEB that is a signal of low activity goes to a low level as illustrated in FIG. 10A—power generation is required.

Thus, for manufactured product A, because the internal power supply IV is caused to generate power continuously and high-speed access is required, if a stabilizing capacitance is small, then variations in the internal power supply IV are large, as illustrated by the solid line in FIG. 10B. As a result, there is a possibility that the access standard may not be met. Therefore, in the case of manufactured product A, the stabilizing capacitance must be made large in order to reduce variations in the internal power supply IV, as illustrated by the broken line in FIG. 10B.

On the other hand, as illustrated in FIG. 10C, in manufactured product B, the internal power supply IV does not generate power when the chip enable signal CEB is at high level, that is, during standby, and the internal power supply N is caused to generate power when the chip enable signal goes to low level. Therefore, if the stabilizing capacitance is large, a rapidity of generation by the internal power supply IV is slowed, as illustrated by the solid line in FIG. 10C, and the access standard may not be met. Therefore, for manufactured product B, it is necessary for the stabilizing capacitance to be small so as to accelerate the rapidity of generation of the internal power supply IV, as illustrated by the broken line in FIG. 10C.

Thus, when manufactured products with different specifications and functions or the like are switched between by bonding options, if the source and drain are fixedly connected to Vss as in the related art configuration illustrated in FIG. 8, the stabilizing capacitance may not be optimized for both of the manufactured products A and B.

### SUMMARY

The present invention is proposed in consideration of the fact described above, and is to provide a semiconductor device that, when the single semiconductor device is switched by bonding options between manufactured products with different functions, is capable of optimizing a stabilizing capacitance of an internal power supply used in the semiconductor device for each of the manufactured products.

An aspect of the present invention is a semiconductor device including: a bonding option pad that is selectively wire-bonded to two voltage supply portions through which external power supply voltages with different power supply potentials are supplied from an external power supply; an internal power supply that is caused to generate a pre-specified internal power supply voltage; and a MOS transistor that stabilizes an output level of the internal power supply voltage, a source and a drain of the MOS transistor are shorted together and connected to the bonding option pad, and a gate of MOS transistor is connected to the internal power supply.

In the above aspect, the internal power supply may output a voltage, that is between a threshold voltage of the MOS transistor and a voltage summing the threshold voltage of the MOS transistor with one of the external power supply voltages supplied to the bonding option pad, to the gate of the MOS transistor as the internal power supply voltage.

The semiconductor device of the above aspect may further include a selection unit that outputs a selected voltage, that depends on a voltage supplied to the bonding option pad to the source and drain of the MOS transistor.

The selection unit may include an inverter connected between the bonding option pad and the source and drain of the MOS transistor.

The MOS transistor may be an NMOS transistor or a DMOS transistor.

The voltage supply portions may include inner leads that are provided at the semiconductor device and through which the external power supply voltages are supplied.

The voltage supply portions may also include power supply pads that are provided at the semiconductor device and through which the external power supply voltages are supplied.

The semiconductor device according to the above aspect may be mounted in a package and the voltage supply portions may include power supply pads that are provided at another semiconductor device mounted in the same package and through which the external power supply voltages are supplied.

The semiconductor device according to the above aspect and a lead group may be sealed by sealing resin, and the lead group may include: a first lead through which an external power supply voltage of a first power supply potential is supplied from the external power supply, and a second lead through which an external power supply voltage of a second power supply potential, which is different from the first power supply potential, is supplied from the external power supply, wherein the first lead or the second lead is wire-bonded to the bonding option pad and the other of the first lead and the second lead is wire-bondable to the bonding option pad but not connected to the bonding option pad.

According to the aspect of the present invention described above, when a single semiconductor device is switched by bonding options between manufactured products with different functions, a stabilizing capacitance of an internal power supply that is used in the semiconductor device may be optimized for each of the manufactured products.

### BRIEF DESCRIPTION OF THE DRAWINGS

Exemplary embodiments of the present invention will be described in detail based on the following figures, wherein:

FIG. 1 is a diagram illustrating structure of a portion of a semiconductor device 10 relating to a first exemplary embodiment;

FIG. 2 is a sectional diagram illustrating schematic structure of a semiconductor package;

FIG. 3 is a graph illustrating a relationship between gate capacitance and gate voltage;

FIG. 4 is a diagram illustrating structure of a portion of a semiconductor device 10 relating to a second exemplary embodiment;

FIG. 5 is a graph illustrating a relationship between gate capacitance and gate voltage;

FIG. 6 is a diagram illustrating an example of a voltage supply section in which bonding option pads are wire-bonded;

FIG. 7 is a diagram illustrating another example of a voltage supply section in which bonding option pads are wire-bonded;

FIG. 8 is a diagram illustrating a related art stabilizing capacitance element;

FIG. 9 is a diagram illustrating specifications of manufactured products A and B that are switched between by a bonding option;

FIG. 10A is a graph illustrating a chip enable signal;

FIG. 10B is a diagram for describing output variations of an internal power supply; and

FIG. 10C is a diagram for describing rapidity of generation of the internal power supply

### DETAILED DESCRIPTION

Herebelow, preferred exemplary embodiments of the present invention are described in detail with reference to the attached drawings. The semiconductor device relating to the present invention may be applied to a semiconductor memory such as, for example, a ROM, a RAM or the like, but applicable semiconductor devices are not to be limited to semiconductor memories.

### First Exemplary Embodiment

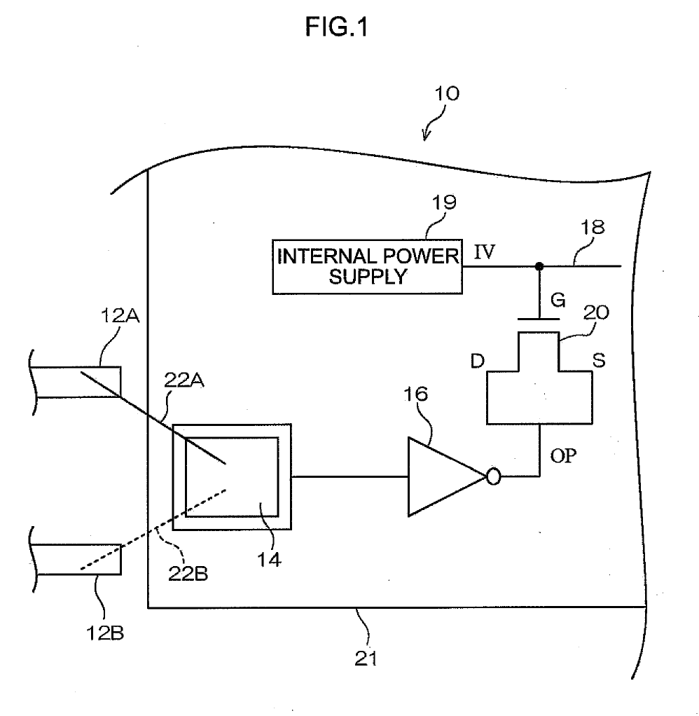

FIG. 1 illustrates schematic structure of a portion of the semiconductor device 10 relating to the first exemplary embodiment of the present invention. As illustrated in FIG. 1, the semiconductor device 10 is provided with a semiconductor integrated circuit 21, which includes a bonding option pad 14, an inverter 16, an internal power supply 19, and an NMOS transistor 20. Two inner leads 12A and 12B, through which voltages of different power supply potentials are supplied, are selectively wire-bonded to the bonding option pad 14. The inverter 16 is connected to the bonding option pad 14. The source and drain of the NMOS transistor 20 are connected to the inverter 16, and the gate is connected to a power supply output line 18, through which a power supply voltage IV outputted from the internal power supply 19 is provided. The NMOS transistor 20 is for stabilizing the output level of the internal power supply voltage IV outputted from the internal power supply 19. The inner leads 12A and 12B each extend to unillustrated outer leads.

A voltage Vcc that serves as an external power supply voltage from an unillustrated external power supply is applied to the inner lead 12A, and a voltage Vss that serves as an external power supply voltage from an unillustrated external power supply is applied to the inner lead 12B. In the present exemplary embodiment, as an example, the voltage Vcc is 2.7 V to 3.6 V and the voltage Vss is 0 V (ground). The internal power supply voltage IV is, for example, a voltage lower than the output power supply voltage Vcc, and is, for example, a voltage for which the output power supply voltage Vcc is reduced by a regulator or the like.

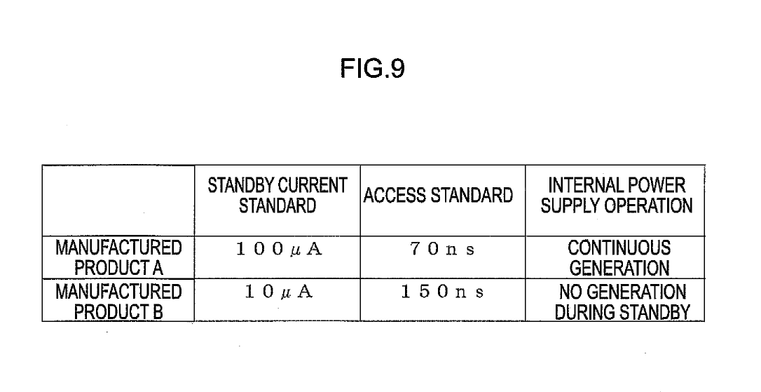

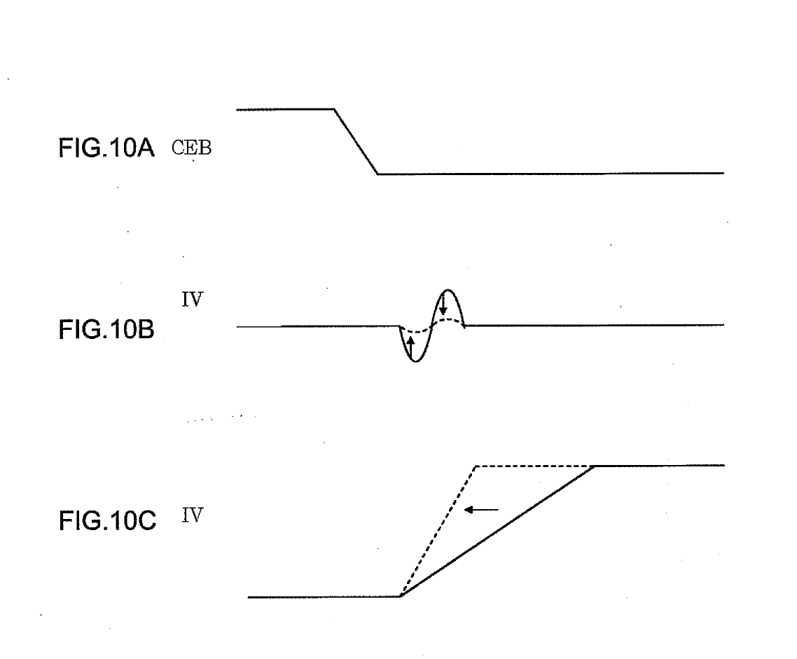

In the present exemplary embodiment, the semiconductor device 10 is a semiconductor device including the functions of manufactured products A and B with, for example, the specifications illustrated in FIG. 9. The semiconductor device 10 functions as the manufactured product A when the inner lead 12A is wire-bonded to the bonding option pad 14 by a wire 22A but the inner lead 12B is not connected by wire-bonding to the bonding option pad 14. The semiconductor device 10 functions as the manufactured product B when the inner lead 12B is wire-bonded to the bonding option pad 14 by a wire 22B but the inner lead 12A is not connected by wire-bonding to the bonding option pad 14.

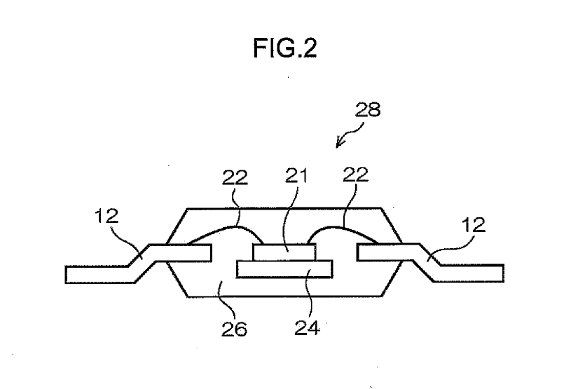

As illustrated in FIG. 2, the semiconductor integrated circuit 21 is disposed on a die pad 24 and is wire-bonded to a lead group 12 by wires 22. Then inner leads of the lead group 12 and the semiconductor integrated circuit 21 on the die pad 24 are sealed with a sealing resin 26, and thus a semiconductor package 28 is constituted.

If the voltage Vcc is inputted to the inverter 16, the inverter 16 outputs the voltage Vss to the source and drain of the NMOS transistor 20 as a bonding option signal OP. If the voltage Vss is inputted to the inverter 16, the inverter 16 outputs the voltage Vcc to the source and drain of the NMOS transistor 20 as the bonding option signal OP.

Therefore, when the semiconductor device 10 is made to function as manufactured product A by a bonding option, which is to say when the inner lead 12A is connected to the bonding option pad 14, the voltage Vcc supplied to the inner lead 12A is inverted by the inverter 16 and the voltage Vss is outputted to the source and drain of the NMOS transistor 20.

Alternatively, when the semiconductor device 10 is made to function as manufactured product B by a bonding option, which is to say when the inner lead 12B is connected to the bonding option pad 14, the voltage Vss supplied to the inner lead 12B is inverted by the inverter 16 and the voltage Vcc is outputted to the source and drain of the NMOS transistor 20.

The source and drain of the NMOS transistor 20 are shorted together and the gate is connected to the internal power supply 19. Thus, the NMOS transistor 20 functions as a capacitance element. That is, the NMOS transistor 20 functions as a stabilizing capacitance element for stabilizing the output level of the internal power supply voltage IV outputted from the internal power supply 19.

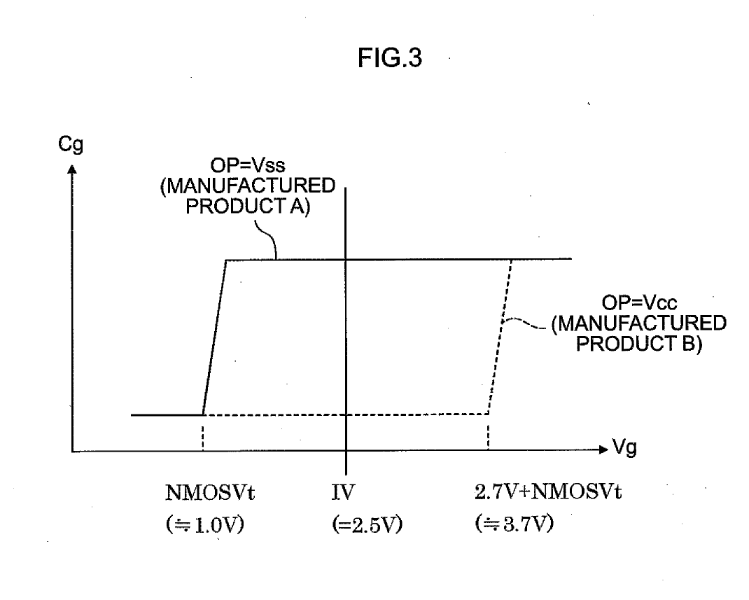

In FIG. 3, a gate voltage Vg dependency of the gate capacitance Cg of the NMOS transistor 20, that is, a relationship between the gate capacitance Cg and the gate voltage Vg, is represented by a solid line for when the bonding option signal OP is the voltage Vss (the case of manufactured product A), and is represented by a broken line for when the bonding option signal OP is the voltage Vcc (manufactured product B).

As illustrated in FIG. 3, when the inner lead 12A to which the voltage Vcc is supplied is connected to the bonding option pad 14 and the bonding option signal OP is the voltage Vss (manufactured product A), the channel is formed and the gate capacitance Cg, that is, the stabilizing capacitance, becomes large when the gate voltage Vg (i.e., the voltage IV supplied by the internal power supply 19) goes above a voltage NMOSVt (approximately 1.0 V), which is a threshold voltage at which the NMOS transistor 20 turns on.

In contrast, when the inner lead 12B to which the voltage Vss is supplied is connected to the bonding option pad 14 and the bonding option signal OP is the voltage Vcc (manufactured product B), the channel is formed and the gate capacitance Cg, that is, the stabilizing capacitance, becomes large when the gate voltage Vg goes above the voltage Vcc (for example, approximately 2.7 V in the present exemplary embodiment) plus the voltage NMOSVt (approximately 1.0 V) (i.e., to approximately 3.7 V or greater). In other words, here, a large stabilizing capacitance and a small stabilizing capacitance may be switched between when the internal power supply voltage IV is between approximately 1.0 V and approximately 3.7 V.

As illustrated in FIG. 3, if, for example, the internal power supply voltage IV is approximately 2.5 V, the stabilizing capacitance is large when the bonding option signal OP is the voltage Vss (manufactured product A), and the stabilizing capacitance is small when the bonding option signal OP is the voltage Vcc (manufactured product B).

In the present exemplary embodiment, a case in which the voltage Vcc is 2.7 V is described. However, if, for example, the voltage Vcc is 3.6 V, then for manufactured product B the channel is formed and the gate capacitance Cg becomes large when the gate voltage Vg goes above the voltage Vcc (approximately 3.6 V) plus the voltage NMOSVt (approximately 1.0 V) (i.e., to approximately 4.6 V or greater).

Thus, the present exemplary embodiment is configured such that, when manufactured product A is selected, the voltage Vss that serves as the bonding option signal OP is inputted to the source and the drain of the NMOS transistor 20 that functions as the stabilizing capacitance element and, when manufactured product B is selected, the voltage Vcc that serves as the bonding option signal OP is inputted to the source and drain. Therefore, a stabilizing capacitance of the internal power supply voltage IV may be optimized for each of the manufactured products A and B when the manufactured products A and B are switched between by the bonding option.

### Second Exemplary Embodiment

Next, a second exemplary embodiment of the present invention is described. Herein, portions that are the same as in the semiconductor device 10 described in the first exemplary embodiment are assigned the same reference numerals, and detailed descriptions thereof are not given.

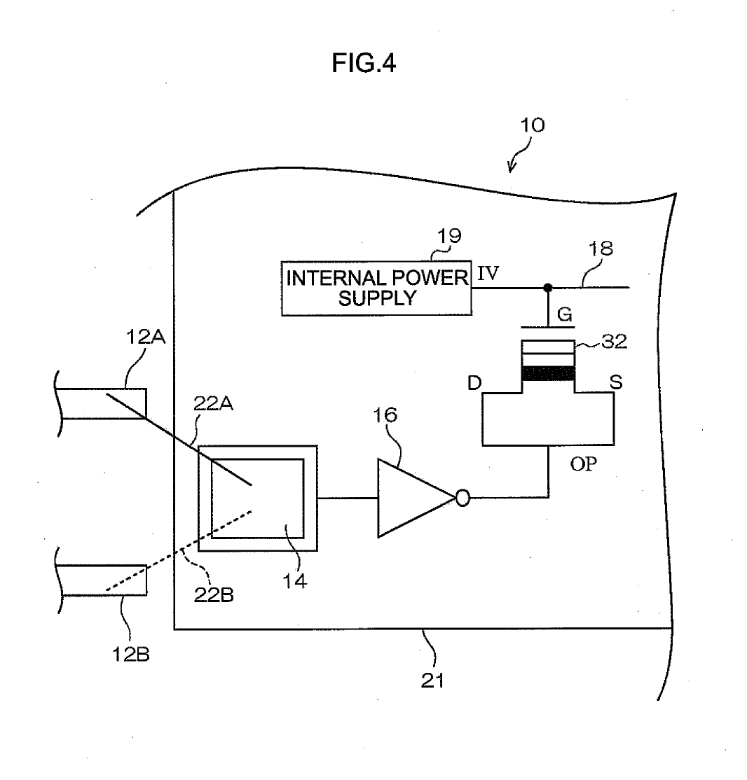

FIG. 4 illustrates a semiconductor device 10 relating to the present exemplary embodiment. The semiconductor device 10 differs from the semiconductor device 10 illustrated in FIG. 1 in that the semiconductor device 10 in FIG. 4 uses a DMOS transistor 32 as the stabilizing capacitance element instead of the NMOS transistor 20. Other structures are the same as in the semiconductor device 10 in FIG. 1 and are not described.

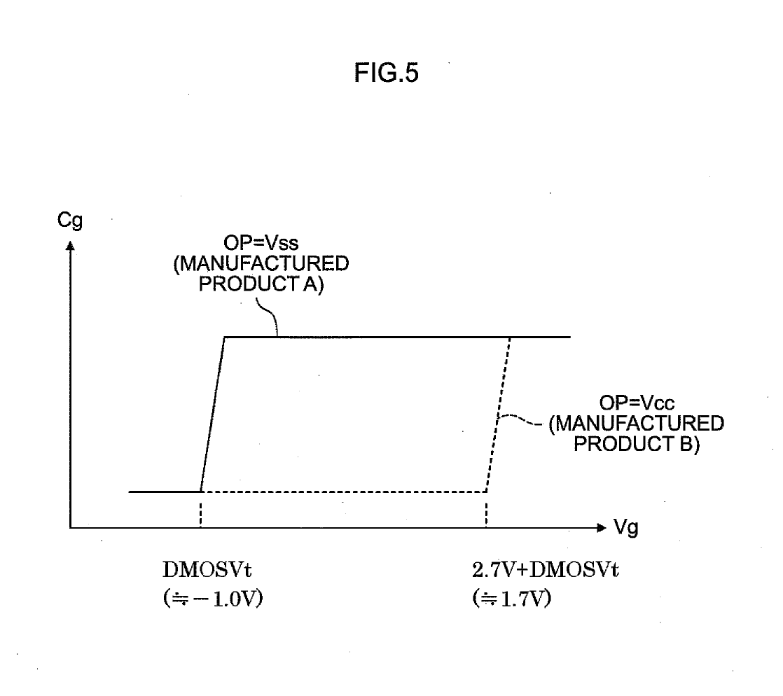

In FIG. 5, a gate voltage Vg dependency of the gate capacitance Cg of the DMOS transistor 32, that is, a relationship between the gate capacitance Cg and the gate voltage Vg, is represented by a solid line for when the bonding option signal OP is the voltage Vss (the case of manufactured product A), and is represented by a broken line for when the bonding option signal OP is the voltage Vcc (manufactured product B).

As illustrated in FIG. 5, when the inner lead 12A to which the voltage Vcc is supplied is connected to the bonding option pad 14 and the bonding option signal OP is the voltage Vss (manufactured product A), the channel is formed and the gate capacitance Cg, that is, the stabilizing capacitance, becomes large when the gate voltage Vg (i.e., the voltage IV supplied by the the internal power supply 19) goes above a voltage DMOSVt (approximately −1.0 V), which is a threshold voltage at which the DMOS transistor 32 turns on.

In contrast, when the inner lead 12B to which the voltage Vss is supplied is connected to the bonding option pad 14 and the bonding option signal OP is the voltage Vcc (manufactured product B), the channel is formed and the gate capacitance Cg, that is, the stabilizing capacitance, becomes large when the gate voltage Vg goes above the voltage Vcc (for example, approximately 2.7 V in the present exemplary embodiment) plus the voltage DMOSVt (approximately −1.0 V) (i.e., to approximately 1.7 V or greater). That is, in this case, a large stabilizing capacitance and a small stabilizing capacitance may be switched between when the internal power supply voltage IV is between approximately −1.0 V and approximately 1.7 V.

In the present exemplary embodiment, a case in which the voltage Vcc is 2.7 V is described. However, if, for example, the voltage Vcc is 3.6 V, then for manufactured product B the channel is formed and the gate capacitance Cg becomes large when the gate voltage Vg goes above the voltage Vcc (approximately 3.6 V) plus the voltage DMOSVt (approximately −1.0 V) (i.e., to approximately 2.6 V or greater).

Thus, the present exemplary embodiment is configured such that, when manufactured product A is selected, the voltage Vss that serves as the bonding option signal OP is inputted to the source and the drain of the DMOS transistor 32 that functions as the stabilizing capacitance element and, when manufactured product B is selected, the voltage Vcc that serves as the bonding option signal OP is inputted to the source and drain. Therefore, a stabilizing capacitance of the internal power supply voltage IV may be optimized for each of the manufactured products A and B when the manufactured products A and B are switched between by the bonding option.

In the present exemplary embodiments, cases are described in which the inverter 16 is provided between the bonding option pad 14 and the NMOS transistor 20 or the DMOS transistor 32. However, configurations are possible in which the inverter 16 is omitted, and the voltage Vss is applied to the inner lead 12A and the voltage Vcc is applied to the inner lead 12B.

Furthermore, what is provided between the bonding option pad 14 and the NMOS transistor 20 or the DMOS transistor 32 is not to be limited to the inverter 16. As long as it is a selection circuit (a logic circuit) that, for example, selects the voltage Vss and outputs the voltage Vss to the drain and source of the NMOS transistor 20 or the DMOS transistor 32 when the voltage Vcc is supplied to the bonding option pad 14, or that selects the voltage Vcc and outputs the voltage Vcc to the drain and source of the NMOS transistor 20 or the DMOS transistor 32 when the voltage Vss is supplied to the bonding option pad 14, circuit configurations are not to be limited to the inverter.

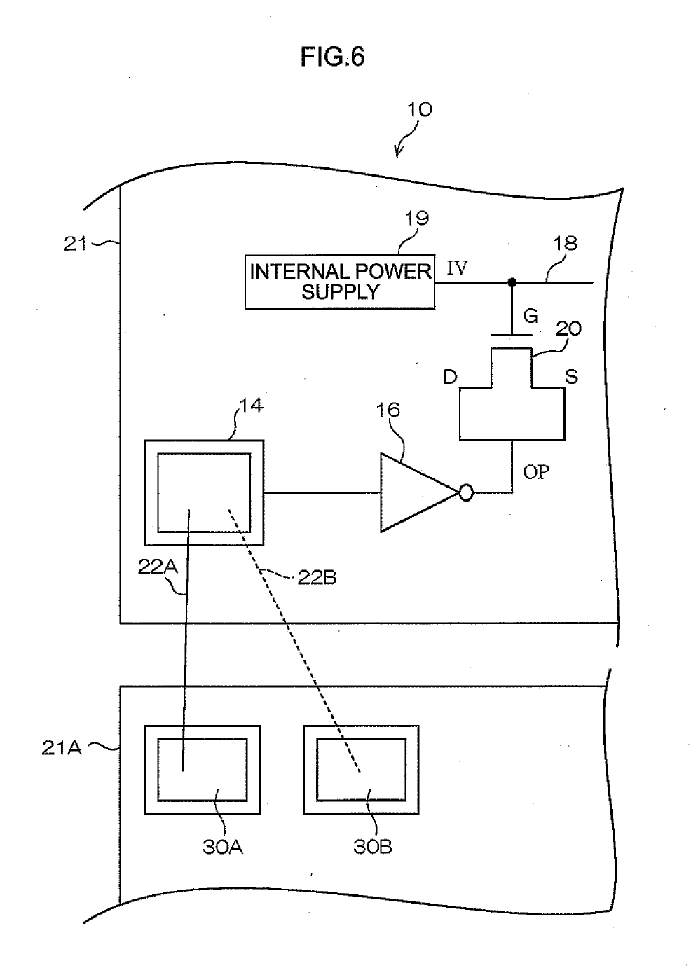

In the present exemplary embodiments, cases are described in which the bonding option pad 14 is wire-bonded to the inner lead 12A or the inner lead 12B. However, what is wire-bonded is not to be limited to inner leads. For example, as illustrated in FIG. 6, a configuration is possible in which a power supply pad 30A through which the voltage Vcc is supplied and a power supply pad 30B through which the voltage Vss is supplied, which are provided at another semiconductor integrated circuit 21A in the same semiconductor package, are selectively wire-bonded.

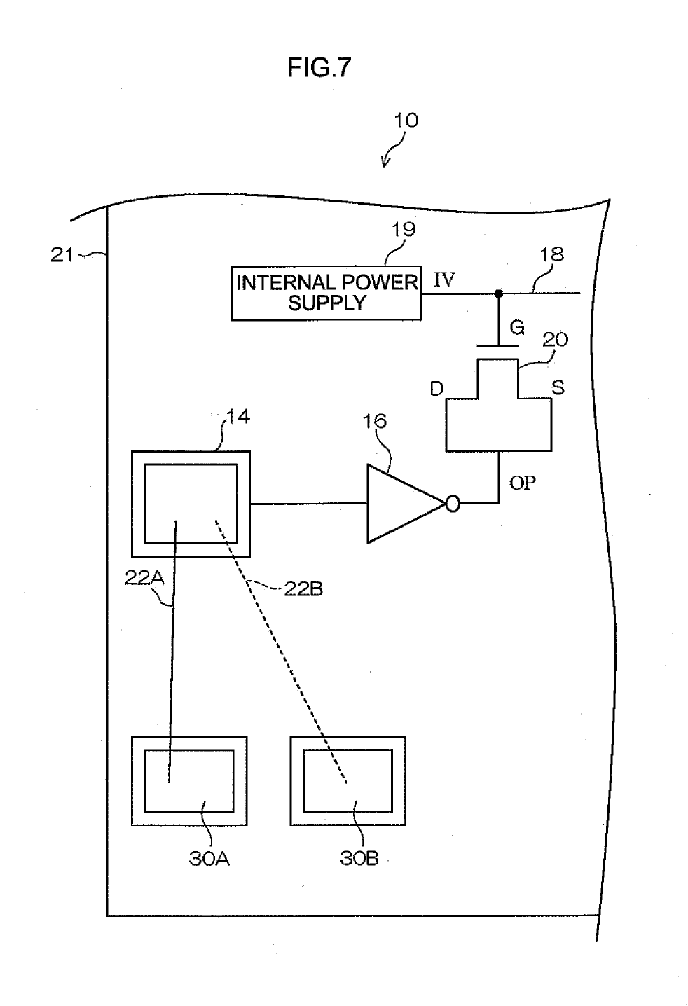

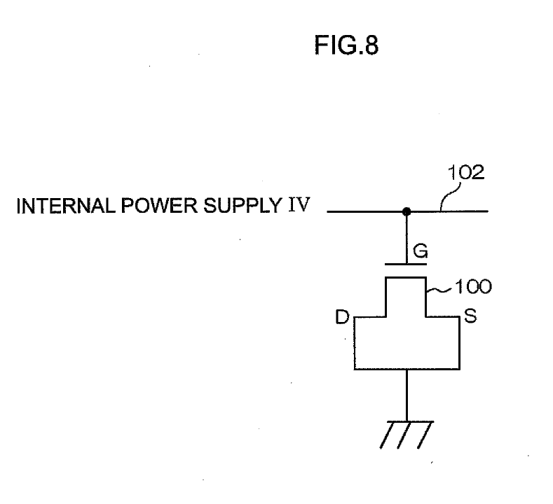

A further configuration is possible in which, for example, as illustrated in FIG. 7, the power supply pad 30A through which the voltage Vcc is supplied and the power supply pad 30B through which the voltage Vss is supplied are selectively wire-bonded, being provided in the same semiconductor integrated circuit 21.

What is claimed is:

1. A semiconductor device comprising:
a bonding option pad that is selectively wire-bonded to two voltage supply portions through which external power supply voltages with different power supply potentials are supplied from an external power supply;
an internal power supply that is caused to generate a pre-specified internal power supply voltage; and
a MOS transistor that stabilizes an output level of the internal power supply voltage, a source and a drain of the MOS transistor are shorted together and connected to the bonding option pad, and a gate of MOS transistor is connected to the internal power supply.

2. The semiconductor device according to claim 1, wherein the internal power supply outputs a voltage, that is between
a threshold voltage of the MOS transistor and
a voltage summing the threshold voltage of the MOS transistor with one of the external power supply voltages supplied to the bonding option pad,
to the gate of the MOS transistor as the internal power supply voltage.

3. The semiconductor device according to claim 1, further comprising a selection unit that outputs a selected voltage, that depends on a voltage supplied to the bonding option pad to the source and drain of the MOS transistor.

4. The semiconductor device according to claim 3, wherein the selection unit comprises an inverter connected between the bonding option pad and the source and drain of the MOS transistor.

5. The semiconductor device according to claim 1, wherein the MOS transistor is an NMOS transistor or a DMOS transistor.

6. The semiconductor device according to claim 1, wherein the voltage supply portions include inner leads that are provided at the semiconductor device and through which the external power supply voltages are supplied.

7. The semiconductor device according to claim 1, wherein the voltage supply portions include power supply pads that are provided at the semiconductor device and through which the external power supply voltages are supplied.

8. The semiconductor device according to claim 1, wherein the semiconductor device is mounted in a package and the voltage supply portions include power supply pads that are provided at another semiconductor device mounted in the same package and through which the external power supply voltages are supplied.

9. A semiconductor package, wherein a semiconductor device according to claim 6 and a lead group are sealed by sealing resin, the lead group including:
a first lead through which an external power supply voltage of a first power supply potential is supplied from the external power supply, and
a second lead through which an external power supply voltage of a second power supply potential, which is different from the first power supply potential, is supplied from the external power supply,
wherein the first lead or the second lead is wire-bonded to the bonding option pad and the other of the first lead and the second lead is wire-bondable to the bonding option pad but not connected to the bonding option pad.
